(19) United States
(12) Patent Application Publication
(10) Pub. No.: US 2026/0071056 A1
(43) Pub. Date: Mar. 12, 2026

(54) Composite material based on coffee waste and its uses

(71) Applicant: Jung Hye KIM, Jardim Morumbi (BR)

(72) Inventor: Seokhun KIM, Irvine, CA (US)

(21) Appl. No.: 19/319,419

(22) Filed: Sep. 4, 2025

(30) Foreign Application Priority Data
Sep. 6, 2024 (BR) 102024018456-4

(51) Int. Cl. C08K 11/00; B09B 3/24; B09B 101/70; C08L 5/00

(52) U.S. Cl. CPC C08K 11/005; B09B 3/24; C08L 5/00; B09B 2101/70; C08L 2201/06

(57) ABSTRACT

The present invention relates to an eco-friendly coffee grounds recycling system. Post-brewing coffee residue (coffee grounds) is prepared, along with other ingredients, to become biodegradable plant containers. This application involves using coffee grounds as the main material, mixing them with organic or inorganic fillers and adding a preservative to produce a biodegradable clay. This clay can be molded into various artifacts, such as decorative items, crafts, bricks, vases, and more.

### CROSS REFERENCE TO RELATED APPLICATION

The present application claims priority to Brazilian Patent Application No. BR 102024018456-4 filed on Sep. 6, 2024, which is incorporated herein by reference in its entirety.

### FIELD OF THE DISCLOSURE

The present disclosure relates to a coffee grounds recycling system under an ecological concept in which coffee residue (coffee grounds) is prepared, together with other ingredients, so as to become a biodegradable composite material after use.

### BACKGROUND

Coffee is one of the most consumed beverages in the world, and approximately 99.8% of the coffee consumed is converted into grounds, most of which are sent to landfills. This process releases large amounts of greenhouse gases, such as methane, causing negative environmental impacts. Currently, most products made from recycled coffee grounds are manufactured by blending synthetic polymeric materials derived from natural sources. Although derived from natural raw materials, these materials undergo synthetic processes that alter their physical and chemical properties, making it difficult for them to fully biodegrade under natural conditions. These products must be disposed of in industrial composting environments under specific conditions. However, in practice, most of these products end up in regular landfills. Products made with synthetic biopolymers that do not fully decompose can form microplastics, polluting soil and water. Therefore, there is an urgent need for a system that allows coffee grounds to be recycled into fully biodegradable products under natural conditions, without the use of synthetic polymeric materials.

The present disclosure proposes a solution to this problem, presenting a method to form a biodegradable clay, where coffee grounds are mixed with organic or inorganic fillers, together with natural polymers (such as natural gums) and food preservatives or of natural origin, allowing it to be molded into various products.

Document BR102020003074, for example, discloses a composition obtained by mixing grounds (preferably coffee grounds and/or yerba mate grounds-combined or not with other waste from renewable natural sources, including: coffee husks, rice husks, paper, wood dust, sunflower husks, fruit and vegetable peels), preferably without any prior chemical treatment, with starch (preferably cassava starch) and/or cellulose (preferably sugarcane bagasse and/or olive pomace), with water (which may be residual), with or without additives, to obtain a fully biodegradable and compostable foamed product, which can be recyclable, in various shapes and sizes, with properties that allow its processing by extrusion, extrusion followed by compression/pressing, and/or only by compression/pressing, and/or even by a molded pulp system, among other techniques used in the plastics industry. After primary use of biodegradable and compostable foam products, they can be recycled to obtain new products and/or reused: (1) for storage/packaging; (2) as plant pots; (3) as organic compost (fertilizer); (4) or simply disposed of correctly.

Portuguese patent PT108887 discloses a composite material based on materials resulting from agro-industrial activity, namely waste, bio-waste, and/or agro-industrial by-products resulting from various industries such as the wine and port wine industries, olive oil industry, tomato industry, carob industry, beer industry, rice industry, coffee roasting and grinding industry, chocolate industry, among others.

The interest and demand, in the state of the art, for the rational use of post-infusion coffee residue, coffee grounds, is clear.

Furthermore, although synthetic biopolymers are derived from renewable sources and known to be biodegradable, they present some significant environmental disadvantages compared to natural biopolymers. First, the production of synthetic biopolymers, such as PLA (polylactic acid), involves complex chemical processes and the use of high temperatures, resulting in significant energy consumption. For example, the PLA manufacturing process involves the fermentation of cornstarch or sugarcane to produce lactic acid, followed by polymerization to create the final material. This process requires large amounts of electricity and heat, increasing carbon emissions and environmental impact.

Furthermore, synthetic biopolymers require specific conditions for degradation. PLA, for example, requires industrial composting facilities with adequate temperatures and humidity, as well as specific microbial activity, to decompose properly. In areas where these facilities are not available, synthetic biopolymers may not degrade completely, resulting in plastic waste that can persist in the environment, compromising their presumed sustainability.

In contrast, natural biopolymers such as alginate, cellulose, and natural gums offer significant environmental advantages. Derived directly from plants, these biopolymers can be extracted through simple processes that require much less energy and do not rely on complex chemical processes or high temperatures, resulting in production with a very low environmental impact and minimal carbon emissions.

Furthermore, natural biopolymers are highly biodegradable, decomposing rapidly in natural environments without the need for specific conditions or industrial facilities. This means that, at the end of their useful life, products made with natural biopolymers do not leave harmful residues and do not contribute to environmental pollution, even in areas without advanced waste management infrastructure.

Therefore, the use of natural biopolymers in the production of customized items blended with coffee grounds, as in the strategy of this application, not only minimizes the environmental impact from the production phase to disposal but also offers a truly sustainable alternative to synthetic biopolymers. This approach aligns with the principles of ecological and efficient production, meeting the growing demands for more responsible and environmentally sustainable industrial practices.

### SUMMARY

The present disclosure relates to an environmentally friendly coffee grounds recycling system. Post-brewing coffee residue (coffee grounds) is prepared, along with other ingredients, to become biodegradable plant containers.

### DETAILED DESCRIPTION

The present disclosure relates to a system for producing biodegradable composite materials from recycled coffee grounds. Embodiments of the invention offer a way to utilize coffee grounds, a widely discarded organic waste, to produce a variety of products in an environmentally friendly way.

Coffee grounds, which are normally discarded, are mixed with organic or inorganic fillers to be transformed into a new type of composite material. During the mixing process, natural biopolymer materials (e.g., alginate, cellulose, natural gums) are added to improve the material's physical properties and increase its bond strength.

This composite material is cured under specific conditions and can then be molded into various shapes. After molding, the material undergoes a drying and coating process to ensure its durability. When necessary, natural coatings, such as shellac, can be applied to add waterproof properties to the final product.

The biodegradable material resulting from at least one embodiment of this invention can be used to manufacture a wide range of products, including plant pots, decorative items, crafts, bricks, and more. These products are environmentally sustainable, decomposing naturally after use and contributing nutrients to the soil.

The present disclosure promotes the sustainable use of resources by recycling coffee grounds, reducing waste and presenting a new way to protect the environment.

Manufacturing Process Overview according to at least one embodiment:

### I. Preferred Embodiment

### 1st Stage: Mixing the Materials

Coffee grounds (in dry or undried form) are mixed with filler (e.g., sand, wood flour, rice hulls, etc.) in a ratio of 8:2. Then, between 5% and 7% of the total weight of the mixture is added of a natural biopolymer material, composed of 4.5% guar gum, 0.5% xanthan gum, and 1% gum arabic, to form the coffee clay powder. The proportions and types of filler and natural biopolymer can be adjusted according to the desired product performance.

### 2nd Step: Preparation of Preservative Solution

Mix up to 0.5% of the clay powder's total weight with a biodegradable preservative dissolved in water. Then, adjust the amount of water to approximately 30% to 60% of the powder's total weight, forming a paste.

### 3rd Stage: Maturation

Place the coffee clay in an airtight container and let it mature in the refrigerator for to 24 hours. Once matured, knead the clay for about 5 minutes to remove the air from the mixture.

### 4th Stage: Molding and Drying

The coffee clay is molded into a mold and, after removing it from the mold, it is left to dry slowly in a well-ventilated place, avoiding direct exposure to sunlight, for at least a week.

### 5th Stage: Coating

If necessary, apply several layers of a natural coating, such as shellac, to protect and increase the durability of the piece.

### II. Alternative Embodiment

### 1st Stage: Mixing the Materials

Coffee grounds (in a dry or undried state) are mixed with the filler material in appropriate proportions. Then, up to 10% of the total weight of the mixture is added of a natural biopolymer material (e.g., alginate, cellulose, natural gums) to form the coffee clay powder. The proportions and types of filler material and natural biopolymer material can be adjusted according to the desired product performance.

### 2nd Step: Preparation of Preservative Solution

Mix up to 0.5% of the clay powder's total weight with a biodegradable preservative dissolved in water. Then, adjust the amount of water to form a clay mass that is easy to mold.

### 3rd Stage: Maturation

Place the coffee clay in an airtight container and let it mature in the refrigerator for about a day. After maturing, knead the clay again to remove the air from the mixture.

### 4th Stage: Molding and Drying

The coffee clay is molded into a mold and, after removing it from the mold, it is left to dry slowly in a well-ventilated place, avoiding direct exposure to sunlight, for at least a week.

### 5th Stage: Coating

If necessary, several layers of a natural coating are applied to protect and increase the durability of the piece.

Comparative analysis of at least one embodiment of the present invention in light of the state of the art

### I. Decomposition Principle

Synthetic Biopolymers: Synthetic biopolymers are materials that are generally derived from biological sources or synthetically produced with biodegradable properties. Decomposition occurs through the action of microorganisms, which break down the polymer into smaller molecules, such as water, carbon dioxide, and methane. However, this process requires specific conditions, such as high temperatures, adequate humidity, an oxygen supply, and intense microbial activity.

Natural Biopolymers: Natural biopolymers are substances extracted from plants or animals, composed primarily of polysaccharides. Examples of natural biopolymers include alginate, cellulose, and natural gums, which decompose naturally through the action of microorganisms in the environment, transforming into simple compounds such as water and carbon dioxide.

### II. Decomposition Rate and Necessary Conditions

Synthetic Biopolymers: The decomposition rate of synthetic biopolymers depends heavily on environmental conditions. In industrial composting facilities, where ideal conditions (temperatures above 50-60° C., high humidity, oxygen) are maintained, complete decomposition can occur within a few weeks. However, in natural environments, decomposition can take 2 to 4 years or even longer, and is often incomplete. The decomposition rate under natural conditions can be as low as 20-50%.

Natural Biopolymers: Natural biopolymers decompose rapidly in the natural environment, usually completely. Even under less than ideal conditions, the decomposition process is faster and more stable than that of synthetic biopolymers.

### III. Environmental Impact

Synthetic Biopolymers: When not fully decomposed, synthetic biopolymers can cause environmental harm. They can fragment into microplastics, contributing to ocean and soil pollution and negatively impacting ecosystems. Furthermore, if not properly managed, synthetic biopolymers can have an environmental impact similar to that of traditional petroleum-derived plastics.

Natural Biopolymers: Natural biopolymers, such as alginate, cellulose, and natural gums, decompose completely in the environment, leaving behind only harmless substances such as water and carbon dioxide. Therefore, they have a minimal environmental impact.

### IV. Applications and Usage Considerations

Synthetic Biopolymers: Synthetic biopolymers are widely used as environmentally friendly alternatives to conventional plastics. However, due to their specific decomposition requirements, it is crucial to ensure they are disposed of and processed correctly to maximize their environmental benefits.

Natural Biopolymers: Natural biopolymers, such as alginate, cellulose, and natural gums, are widely used in industries such as food, pharmaceuticals, and cosmetics. Their ability to readily biodegrade in the natural environment makes them a more environmentally friendly option, with fewer concerns about disposal.

In short, synthetic biopolymers require specific conditions for complete decomposition, and when these conditions are not met, decomposition can be partial and slow, causing potential environmental impacts. In contrast, natural biopolymers, such as alginate, cellulose, and natural gums, decompose completely in the natural environment and do not pose the same environmental risks, making them a more sustainable choice.

### Effects of At Least One Embodiment of the Invention

Environmental Benefits: Turning coffee grounds into clay and promoting the use thereof or biodegradably disposing thereof prevents greenhouse gas emissions and environmental pollution associated with landfill disposal. During the clay transformation process, the coffee grounds are physically stabilized, and the preservative prevents microbial decomposition, resulting in a product that can degrade naturally in soil or water.

Economic Benefits: At least one embodiment of this invention allows the conversion of coffee grounds into high-value products, minimizing resource waste. Furthermore, the proposed method can be used in small facilities without the need for major investments in infrastructure or material costs, allowing the production of a variety of products.

Areas of Application: At least one embodiment of the invention can be used to manufacture a wide range of products, including decorative items, crafts, bricks, vases, and other materials made from clay. These products are environmentally sustainable and can be applied in various industrial sectors.

The above description is intended to be illustrative only with respect to the details of the formulation and its method of preparation. The percentages given herein are by weight unless otherwise indicated. Changes in form and proportion of parts, as well as the substitution of equivalents, are contemplated as circumstances suggest or make convenient. Similarly, although plant pots and solid cosmetic products have been described herein in conjunction with two specific embodiments, many alternatives, modifications, and variations will be evident to those skilled in the art in light of the description presented herein.

1. A method for forming biodegradable clay using coffee grounds, characterized in that it can be used alone or mixed with organic or inorganic filler materials, together with a natural biopolymer binding agent (e.g., alginate, cellulose, natural gum) and a biodegradable preservative, comprising:
a ratio of coffee grounds to filler material of 8:2, which can be adjusted as needed;
a natural biopolymer binding agent;
a biodegradable preservative dissolved in water before being added to the clay mixture;
in which the clay is then molded and subjected to a drying process.

2. Use of clay as defined in claim 1, characterized in that it is for manufacturing biodegradable products, such as decorative articles, crafts, bricks, vases, among others, comprising, if necessary, the application of a natural coating layer, such as shellac, to protect and improve the durability of the product.

3. Clay maturation method as defined in claim 1, characterized in that the clay is left to mature in an airtight container in the refrigerator for 12 to 24 hours.

4. Method of molding and drying clay as defined in claim 1, characterized in that the molded clay is left to dry slowly in a well-ventilated place, with a temperature between 18° C. and 25° C. and humidity between 40% and 60%, for at least one week.

5. Method of manufacturing biodegradable clay characterized by using natural biopolymers such as alginate, cellulose or natural gum mixed with coffee grounds, where the clay can be molded into various products and, if necessary, coated with shellac or another natural coating to increase its durability.
